(19) United States
(12) Patent Application Publication
(10) Pub. No.: US 2005/0085853 A1
(43) Pub. Date: Apr. 21, 2005

(54) Collagen delivery assembly with blood perfusion holes

(76) Inventors: Andrew Thomas Forsberg, Minneapolis, MN (US); Brad Huss, Chanhassen, MN (US)

Correspondence Address: L. Grant Foster;HOLLAND & HART LLP, 555 - 17th Street, Suite 3200, P.O. Box 8749, Denver, CO, 80201, US

(21) Appl. No.: 10/686,470

(22) Filed: Oct. 15, 2003

(51) Int. Cl. A61D 1/00

(52) U.S. Cl. 606/213

(57) ABSTRACT

The present invention provides a vascular closure device wherein perforations are provided to allow a collagen to be wetted prior to deployment.

### FIELD OF THE INVENTION

The present invention relates to a vascular closure devices and, more particularly, to a vascular closure device having blood perfusion holes to facilitate collagen wetting.

### BACKGROUND OF THE INVENTION

Vascular closure devices are generally known in the art. FIG. 1 shows a conventional vascular closure device 100 useful in closing arterial punctures. Device 100 may include an anchor 102, a bypass tube 104, a hemostatic collagen sponge 106, a suture 108, a carrier tube 110, a tamper tube 112, a device sleeve 114, a reference indicator 116, and a device cap 118.

Using device 100, anchor 102 is deployed to seal a vessel 202, see FIG. 2. Device 100 is removed leaving anchor 102 deployed in vessel 202, hemostatic collagen sponge 106 above anchor 102 with suture 108 threaded from anchor through sponge 106, exiting the patient, and into device 100. Tamper tube 112 is exposed during this step. With tension on suture 108, tamper tube 112 uses suture 108 as a guide to advance collagen sponge 106 to complete the seal of vessel 202. Once the seal is completed, tamper tube 112 and excess suture 108 are removed.

Prior to tamping collagen sponge 106, time must be allowed for collagen sponge 106 to wet, which can cause complications and takes a significant amount of time because the collagen sponge is almost entirely dry until bypass tube 104 and carrier tube 110 are removed. Thus, it would be desirous to develop a vascular closure device that allowed for wetting the collagen sponge prior to removal of the tubes.

### SUMMARY OF THE INVENTION

To attain the advantages and in accordance with the purpose of the invention, as embodied and broadly described herein, collagen deployment tool is provided. The collagen deployment tool comprises a tube packed with a collagen. The tube contains at least one perforation that allows wetting of the collagen prior to removal of the tube.

The foregoing and other features, utilities and advantages of the invention will be apparent from the following more particular description of a preferred embodiment of the invention as illustrated in the accompanying drawings.

### BRIEF DESCRIPTION OF THE DRAWING

The above and other objects and advantages of the present invention will be apparent upon consideration of the following detailed description, taken in conjunction with the accompanying drawings, in which like reference characters refer to like parts throughout, and in which:

FIG. 1 is a cross-sectional view of a conventional vascular closure device;

FIG. 2 is a perspective view of tamping a collagen sponge; and

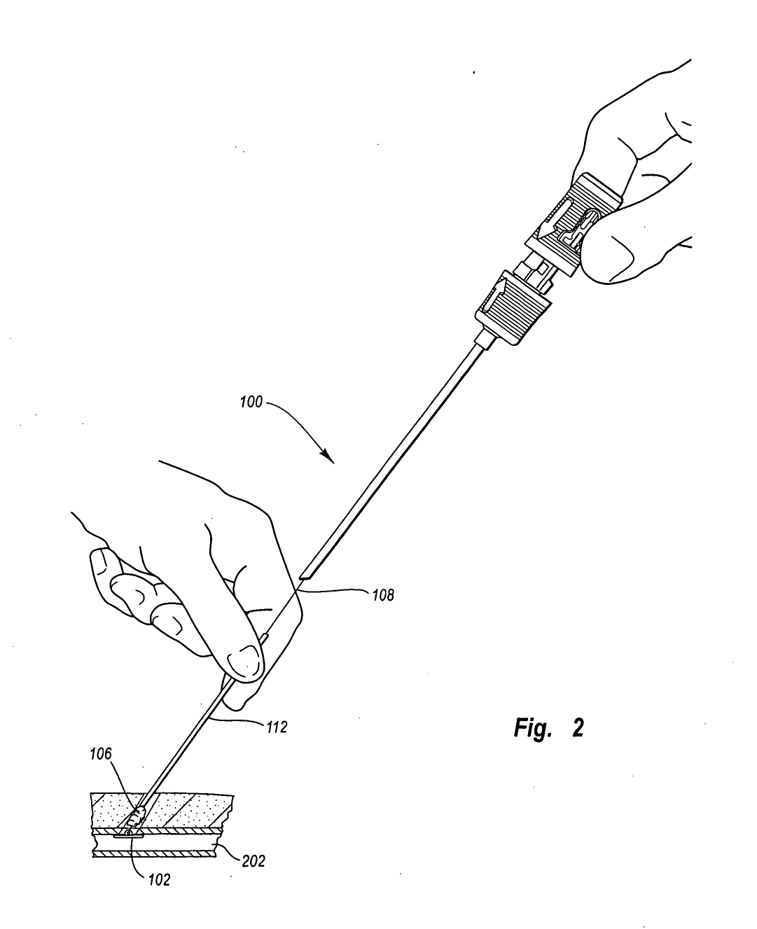

FIG. 3 is a view of a collagen deployment device consistent with the present invention.

### DETAILED DESCRIPTION

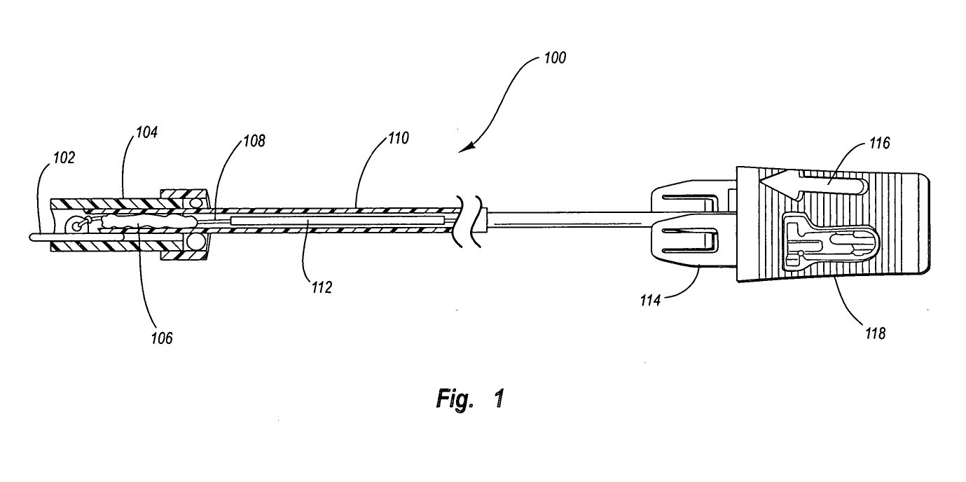

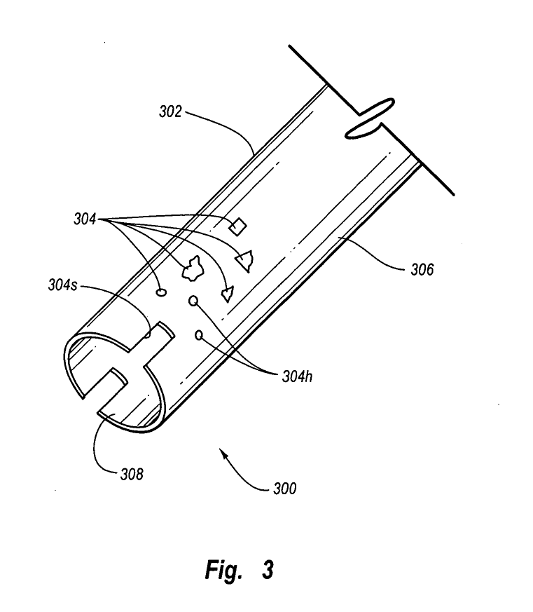

The present invention will now be described with reference to FIG. 3. FIG. 3 shows collagen deployment device 300. Device 300 could be part of a larger tool, such as, for example, a vascular closure device similar to vascular closure device 100 (FIG. 1). Collagen deployment device includes a tube 302. Tube 302 could be a carrier tube. In this case, tube 302 is similar in all respects to a conventional carrier tube, but tube 302 includes perforations 304. Perforations 304 can be a series of holes arranged randomly as shown. Instead of random placement, perforations 304 could be placed in a predefined pattern. Alternatively, perforations 304 can be slots, whether vertical, horizontal, or diagonal, or some combination of thereof. Also, perforations can be consistent holes or slots size, a combination of holes and slots of consistent size, or a combination of holes and slots of various or similar sizes. Further, while shown as circular holes and rectangular slots, the holes and slots could be numerous shapes and sizes, such as, triangular, square, rectangular, elliptical, trapezoidal or the like. Moreover, the holes and slots could have irregular shapes.

Perforations 304 can be open pathways from an external side 306 of tube 302 to an internal side 308 of tube 302. Alternatively, a membrane (not shown) could be used to cover perforations 304. The membrane could be designed to pass liquids in one direction or to filter particulate, or the like.

As one of ordinary skill in the art would recognize on reading the disclosure, any number of perforations 304 configurations are possible. However, for vascular closure devices, it has been found that at least one slot 304ₛ towards the distal end of carrier tube 302 and a number of laser drilled holes 304ₕ arranged subsequent the slot allow for adequate wetting of collagen 106.

Finally, as shown, perforations 304, whether slots or holes, are of consistent dimensions. While providing a uniform pattern of perforations of uniform dimensions is convenient, it is not necessary. Each hole or slot can have a different arrangement for other perforations.

While the invention has been particularly shown and described with reference to embodiments thereof, it will be understood by those skilled in the art that various other changes in the form and details may be made without departing from the spirit and scope of the invention.

1. A collagen deployment assembly, comprising:
a tube;
the tube adapted to deliver and deploy a collagen;
at least one perforation; and
the at least one perforation contained on the tube to allow the collagen being delivered and deployed to wet prior to deployment.

2. The assembly according to claim 1, wherein the tube comprises a carrier tube.

3. The assembly according to claim 1, wherein the tube comprises a bypass tube.

4. The assembly according to claim 1, wherein the at least one perforation comprises a hole.

5. The assembly according to claim 1, wherein the at least one perforation comprises a slot.

6. The assembly according to claim 1, wherein the at least one perforation comprises a plurality of perforations.

7. The assembly according to claim 6, wherein the plurality of perforations comprise a combination of slots and holes.

8. The assembly according to claim 6, wherein the plurality of perforations comprise a predefined pattern.

9. The assembly according to claim 1, wherein the tube comprises a distal end and a proximate end; and
the at least one perforation comprises at least one slot arranged at the distal end of the tube and at least one hole arranged between the at least one slot and the proximate end of the tube.

10. The assembly according to claim 1, comprising at least one membrane, the at least one membrane for covering the at least one perforation.

11. A collagen deployment assembly, comprising:
a tube;
the tube adapted to deliver and deploy a collagen;
means for wetting adapted to allowing a solution to wet the collagen prior to deployment.

12. The closure device according to claim 11, wherein the means for wetting is at least one perforation.

13. The closure device according to claim 11, wherein the means for wetting is at least one hole.

14. The closure device according to claim 11, wherein the means for wetting is at least one slot.

15. A vascular closure device, comprising:
a collagen;
a tube;
at least a part of the collagen resides in the tube; and
at least one perforation in the carrier tube to allow the collagen to be wetted prior to deployment.

16. The vascular closure device according to claim 15, wherein the tube is a carrier tube.

17. The vascular closure device according to claim 15, wherein the tube is a bypass tube.

18. The vascular closure device according to claim 15, wherein the at least one perforation is at least one of a hole and a slot.

19. The vascular closure device according to claim 15, wherein the at least one perforation has at least one shape.

20. The vascular closure device according to claim 19, wherein the at least one shape comprises at least one of a triangle, a circle, a square, a rectangle, a trapezoid, and an ellipse.
